(19) United States
(12) Patent Application Publication
(10) Pub. No.: US 2010/0287067 A1
(43) Pub. Date: Nov. 11, 2010

(54) Method of Distributing Video Content Via the Internet

(75) Inventors: Scott Abramowitz, New York, NY (US); Robert Alexander, New York, NY (US)

Correspondence Address: COHEN, PONTANI, LIEBERMAN & PAVANE LLP, 551 FIFTH AVENUE, SUITE 1210, NEW YORK, NY, 10176, US

(73) Assignee: Independent Film Development Group LLC, New York, NY (US)

(21) Appl. No.: 11/992,512

(22) PCT Filed: Sep. 27, 2006
(86) PCT No.: PCT/US06/37462

§ 371 Date: Jul. 14, 2010

Related U.S. Application Data
(60) Provisional application No. 60/721,034, filed on Sep. 27, 2005.

(51) Int. Cl. G06F 15/16; G06F 17/30; G06Q 30/00

(52) U.S. Cl. 705/27; 707/769; 709/219; 707/E17.014

(57) ABSTRACT

A system and methods for transmitting, distributing and storing video content using a proprietary format to provide undisturbed playback among an unlimited number of various customer devices supporting copyright control provisions, wherein a database at a service provider is searched to locate a title of audio, video or audio/video content associated with the title. At least one link indexed to the title is presented for selection upon identification of the title in the database. The selection of the link is received at the service provider via the Internet, and a check is performed to determine whether a download of a data file incorporating the audio, video or audio/video content associated with the link indexed to the title has been requested. A determination is made as to whether permanent ownership of the requested audio, video or audio/video content associated with the title is desired and each segmented element is downloaded to a computer via the Internet for playback based on sequence codes in each segmented element.

This application claims priority from U.S. Provisional Patent Application Ser. No. 60/721,034 which was filed on Sep. 27, 2005.

### BACKGROUND OF THE INVENTION

1. Field of the Invention

2. Description of the Related Art

The present invention generally relates to the field of remote accessing and, more particularly, to a system and methods for transmitting, distributing and storing audio, video or audio/video content using a proprietary format to provide undisturbed playback among an unlimited number of various customer devices supporting copyright control provisions.

### SUMMARY OF THE INVENTION

The present invention is directed to a system and methods for transmitting, distributing and storing video content using a proprietary format to provide undisturbed playback among an unlimited number of various customer devices supporting copyright control provisions. The system for distributing audio, video or audio/video content, comprises: a service provider center having a control center server and a remote computer. The control center server segments a downloaded data file incorporating the audio, video or audio/video content associated with at least one link indexed to the title. A distribution center server is configured to receive the segmented data file for distribution via the Internet to at least one remotely located computer. A module is located in the at least one remotely located computer for initiating downloads of the segmented data file to the computer.

One disclosed embodiment of the method for distributing audio, video or audio/video content, comprises accessing a database at a service provider to perform a search of the database via the Internet, searching the database at the service provider to locate a title of the audio, video or audio/video content associated with the title, presenting at least one link indexed to the title for selection at a home page of the service provider upon identification of the title in the database, receiving the selection of the at least one link at the service provider via the Internet, determining whether a download of a data file incorporating the audio, video or audio/video content associated with the at least one link indexed to the title has been requested, determining whether permanent ownership of the requested audio, video or audio/video content associated with the title is desired if a download of the data file has been requested, segmenting the data file into a predetermined number of elements at a control center server and distributing each of the segmented elements to a respective distribution server, and downloading each segmented element from the respective distribution server to a computer via the Internet for playback based on sequence codes in each segmented element.

Another embodiment of the method for distributing audio, video or audio/video content, comprises receiving payment to permit access to a website to upload digitally encoded audio, video or audio/video data files to a database for distribution to a consumer or user, accessing the website and uploading the digitally encoded data files to the website subsequent to payment of the fee, associating the uploaded data files with specific titles to permit keyword searching of the database, searching the database at the service provider to locate a title of the audio, video or audio/video content associated with the title upon payment of the fee, presenting at least one link indexed to the title for selection at a home page of the service provider upon identification of the title in the database, receiving the selection of the at least one link at the service provider via the Internet, determining whether a download of a data file incorporating, the audio, video or audio/video content associated with the at least one link indexed to the title has been requested, determining whether permanent ownership of the requested audio, video or audio/video content associated with the title is desired if a download of the data file has been requested, receiving payment for permanent ownership of the requested audio, video or audio/video content associated with the title, segmenting the data file into a predetermined number of elements at a control center server and distributing each of the segmented elements to a respective distribution server upon receipt of payment, and downloading each segmented element to a computer via the Internet for playback based on sequence codes in each segmented element.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is a schematic block diagram of the system for distributing audio, video or audio/video content in accordance with an embodiment of the invention;

FIG. 2 is an exemplary block diagram illustrating the wheel/spoke arrangement of a search result in accordance with an embodiment of the invention;

FIG. 3 is a schematic block diagram of a business model associated with distributing audio, video or audio/video content in accordance with the embodiment of FIG. 1; and

FIGS. 4(a) and 4(b) is a flow chart illustrating the steps of the method of the invention.

### DETAILED DESCRIPTION OF THE PRESENTLY PREFERRED EMBODIMENTS

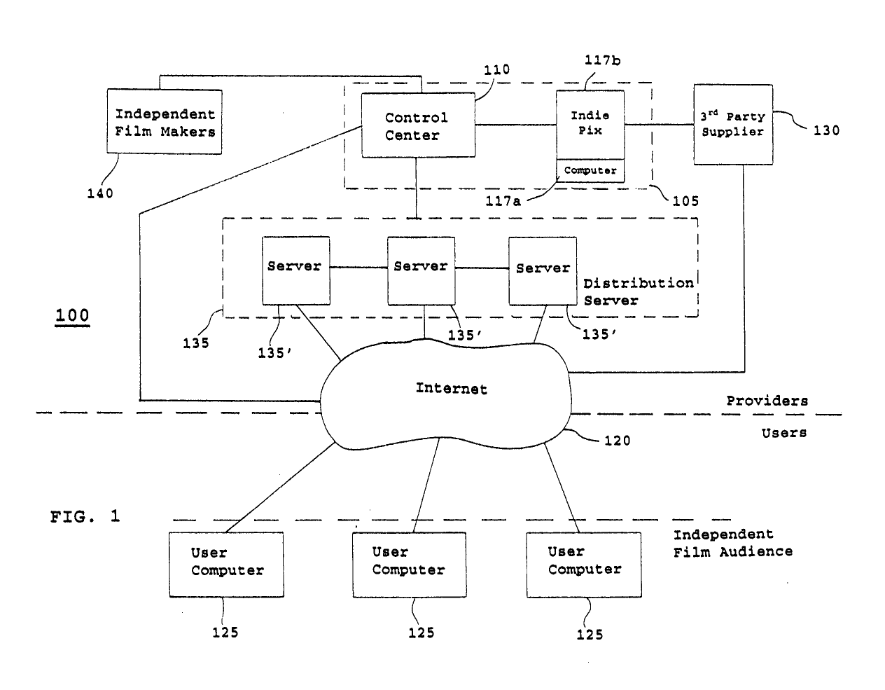

The present invention is directed to a system and methods for transmitting, distributing and storing video content using a proprietary format to provide undisturbed playback among an unlimited number of various customer devices supporting copyright control provisions. FIG. 1 is a schematic block diagram of the system 100 for distributing audio, video or audio/video content in accordance with an embodiment of the invention. Consumer or user interactions with a distribution control center server 110 of a service provider 105, is mediated by a predetermined software application that is stored on an service provider computer 117a of the service provider 105 that is accessed at the consumer's computer 125 via the Internet 120. The system and methods in accordance with embodiments of the invention are intended to be offered to consumers under the trademark “IndiePix”. Here, the consumer or user may use his computer to access the distribution control center server 110 over the Internet 120 via a conventional URL, such as IndiePix.net, which provides a consumer with access to an IndiePix website 117b, as discussed below. In the preferred embodiment, the distribution control center server 110 is an IndiePix Control Center (IPCC) 110 comprising proprietary software that is used to execute various computing and interactive functions, as discussed below. It should be readily appreciated that the computer 125 can be any one of a Personal Digital Assistant, any of a number of commercial available digital players, such as an iPod or any other web enabled device.

Access to IPCC 110 is accomplished via a computer program, e.g. IPCC software, which is installed in the computer 125 of the user or consumer. Typically, the consumer receives the IPCC software by downloading it from the IndiePix web site 117b or from another location, or by installing the IPCC software from a promotional digital video disk (DVD) that contains the software. Installation of the IPCC software occurs when the consumer or user chooses to access IndiePix products through third party promotions, and by other similar methods. However, installation does not occur automatically. Rather, the IPCC software is only installed subsequent to providing the user with the option to approve installation of the software.

After installing the IPCC software, it then becomes possible for a consumer to find an audio, video or audio/video title of interest located in a database (not shown) of the IndiePix web site 117b. Once the consumer has identified an audio/video title of interest on the IndiePix web site, the audio/video title may be selected from links presented on the home page of the IndiePix web site 117b, a search for a title, or from the result of browsing the IndiePix web site. Naturally, it will be appreciated that the audio/video title is associated with an audio, video or audio/video file (e.g., a film or movie) that the consumer or user wishes to access. In accordance with the disclosed embodiments, when a consumer or user selects a title, a webpage with complete information about the audio, video or audio/video file is constructed and presented to the consumer using known dynamic programming techniques. In the preferred embodiment, the search is knowledge or a semantic based search in accordance with an International Standards Organization (ISO) standard', such as ISO 11179 (1999) and ISO 2395 (1999).

In general, independently produced films are not well known because they are not introduced to the public with multi-million dollar ad budgets. The ability to search for titles in the database is therefore key to making titles accessible to consumers having an interest in such films. In accordance with the disclosed embodiments, a standard search includes the ability to search by title, director/filmmaker, and other key variables defining the titles, such as film festival where exhibited, awards won, etc. These searches are conducted using standard, indexed search techniques. Pursuant to implementation of the disclosed embodiments, the information upon which these searches are conducted are compiled, verified and stored for use in searching the database.

In accordance with the disclosed embodiments, multiple keywords are indexed to each title of an audio, video or audio/video file. It is also possible to perform advanced searches on the IndiePix web site 117b, where a “target” title appears at the center of the display of the computer 125 of the consumer or user. Here, the target title contains a corresponding match indicated by the consumer or user.

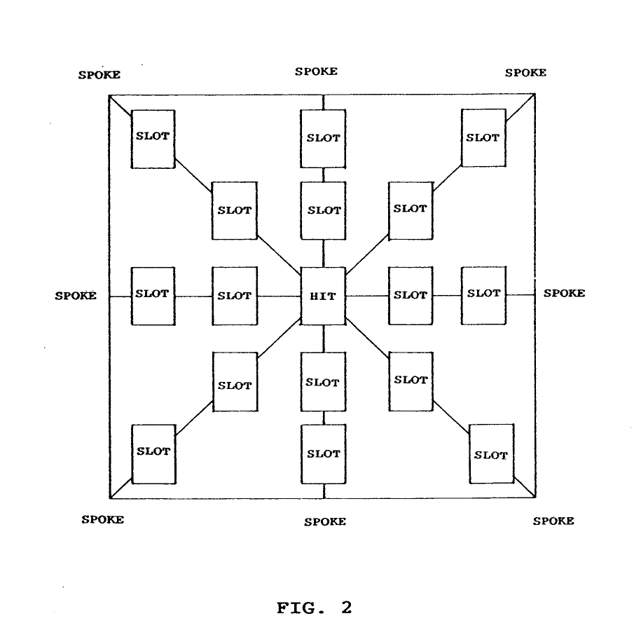

In accordance with the disclosed embodiments, the search presented to the consumer or user is arranged in a manner such that the searches “radiate” out from the target (i.e., a “hit”) in much the manner as the spokes on a wheel, as shown in FIG. 2. Here, the dimension of the search is defined by the “keywords” used to perform the search. Examples of dimensions of the search include: geographical location of the title, filmmaker or keywords representing the theme of the title. In an embodiment, near matches are arranged along these spokes so as to suggest the range of titles that approximate the consumer's keyword search. Such a search capability is uniquely programmed for the present invention and includes specific ways in which the dimensions represented by the spokes are dynamically defined, selected titles are positioned along the spokes in the slots, and in which “near match” titles are positioned along the dimensions in proximity to the center of the wheel/spoke arrangement. In accordance with disclosed embodiments, each title is indexed to multiple “tags”, where the tags are analyzed during a search to locate other titles indexed to each tag so as to determine whether there is a correspondence between the titles or tags. If a correlation is found, then the link is placed in a slot of the wheel/spoke arrangement based on the relevance to the core title.

With additional reference to FIG. 2, a consumer or user may click on each title or slot and obtain details associated with the title, such as year of manufacture, director, actors, duration, etc. Upon selection of a particular title, the wheel/spoke arrangement would be redrawn, where the newly selected title would then appear at the center of a new wheel/spoke arrangement. In this manner, the consumer or user may perform knowledge based browsing or searching to locate specific titles of interest. The present invention is not limited to searching on specific titles. In contemplated embodiments, it is possible to perform a search on a specific theme.

The search result that is presented to the user is based on a predetermined number of titles or themes located from the search. In the preferred embodiment, the number of titles or themes presented to the user is 8, where the most relevant title or theme is arranged at the center of the search. It should also be noted that it is possible to present an empty search to the consumer or user if a corresponding match to the search presented by the user is not retrieved.

Having retrieved a particular title of interest, e.g. an audio, video or audio/video file associated with a particular film, the consumer or user has several options with respect to the retrieved title. In accordance with commercial aspects of the contemplated embodiments of the invention, the consumer or user may pay a fee to purchase a DVD that may be manufactured to order, depending on availability, or shipped from one of several wholesalers or third party suppliers 130 that may stock the specific title. A credit card provided by the consumer or user that can be maintained on file can be used for payment. Naturally, it will be appreciated that other traditional forms of payment may also be used, where the consumer or user would mail traditional forms of payment, such as cash, money orders or checks, which would be applied to an account of the consumer or user that is maintained at the IndiePix website 117b. Alternatively, payment for download of the data file may be achieved by way of known Internet payment methods, such as PayPal® or CyberCash®.

The consumer or user may also pay a fee to purchase a data file incorporating the audio, video or audio/video information associated with the particular title of interest that is downloaded from the IndiePix website 117b via the IPCC 110 to distribution servers 135 and to the consumer's computer 125 via the Internet 120 for subsequent transfer to a blank DVD disk provided by the consumer for permanent ownership, i.e., download and burn-to-own. Once payment is completed, ownership of the downloaded title is transferred to the consumer in much the same manner and with the same effect as if it had been purchased in a retail store. Disks created by this process will be fully compatible with standard consumer DVD players and will have full compatibility with standard and advanced (e.g. LCD and/or Plasma) television display screens at quality levels equal to (or above) existing retail DVD disks.

Finally, the consumer or user may pay a fee to purchase a data file incorporating the audio, video or audio/video information of the title for viewing for a temporary period of time, i.e., download-to-rent. Here, the data file is only transferable to a specific disk that is provided by the IndiePix provider 105 or encoded via the IPCC 110. The audio, video or audio/video information of the data file is transferred to this specific disk. However, subsequent titles are transferred to that same disk, after erasure of the prior contents of the disk. Typically, the consumers or users will be required to posses a DVD drive that is configured to read such re-writable disks. Irrespective of such a requirement, the proprietary software of the IPCC 110 verifies that a properly coded disk is in the disk drive of the consumer's computer 125, and that the prior contents have been erased before transferring the new file to that disk.

Customers or users may choose to become rental members of audio, video or audio/video titles. For customers choosing to become members, they will pay a monthly subscription fee for a fixed duration, such as at least 6 months. As part of this subscription, the member is provided with one or more re-writable disks and a coupon worth a specified amount toward the purchase of a DVD re-write capable drive that may be connected externally to the member's personal computer 125.

In other contemplated embodiments, video or audio/video information is viewed in real-time, i.e., streamed from the IndiePix website 117b via the Internet 120, by way of the IPCC 110 and the distribution server 135. In the preferred embodiments of the invention, the download of the data file is initiated from the computer of the user 125 via the proprietary IPCC software located at the user computer, i.e., the data file is “pulled-down” from the distribution server 135.

Prior to download of the data file, it is encoded with an identifiable digital “watermark”—encoded randomly throughout the data file—that specifies the identity of the consumer or user that initiated the download of the data file. This watermark remains with the data file in any subsequent copies, and provides deterrence against illegal copying for commercial gain. Such watermarking may be accomplished using known watermarking methods, such as via the software package MPEGEscort™ manufactured by PixelTools. In accordance with the contemplated embodiments of the invention, the watermark can be downloaded with or without the data file. In embodiments where the data file is downloaded without the watermark, it is downloaded and inserted into the downloaded data file at the consumer' computer 125.

It is advantageous to reduce server loads, as well as increase processing speed by reducing the processing bandwidth, i.e., the amount of information downloadable from a webserver over a prescribed period of time. As a result, the data file to be downloaded is segmented into a predetermined number of elements, where the total number of elements is a fixed power, such as a power of 2. In the preferred embodiment, the fixed power is in the order of not less than 2¹⁰. The segmentation of the file to be downloaded occurs at the IPCC server 110. As a result, server loading is minimized because the load is distributed among the multiple remote servers 135′ shown in FIG. 1. In addition, the speed with which the file is downloaded or streamed to the consumer or user is increased. Moreover, a high level of security is provided, because the data file is segmented and distributed among several servers such that unauthorized users cannot access the entire data file from a single point of access.

In accordance with the contemplated embodiments, each element of the sectioned data file is provided with a predetermined encoded sequence number. In addition, each element of the sectioned file that is delivered to the consumer is allocated randomly to each of the distribution servers 135′, each of which separately delivers its portion of the data file to the consumer or user via the Internet 120.

Typically, the data file is transmitted in MPEG2 format. In an embodiment of the present invention, the selected data file is compressed into MPEG4 format prior to being downloaded so as to increase the speed at which the data file can be downloaded. Subsequent to downloading, the compressed file is decompressed into MPEG2 format, which causes a loss of resolution. However, in certain embodiments, the loss of detail associated with such a loss of resolution is acceptable, for example, such as when the file is played back in a portable player, such as an IPOD, a Play Station Player (PSP) or any other web enabled device known or hereafter developed. Here, the downloaded file is provided to such players in MPEG4 format.

With additional reference to FIG. 1, the IPCC 110 maintains communication between the computer 125 of the consumer or user and the remote servers 135′, and manages the download of the file segments from each server, pursuant to initiation of the download request by the proprietary IPCC software at the consumer's computer 125. After all the elements are received by the consumer or user at their computer, the IPCC 110 organizes the file elements in an appropriate order based on the sequence codes in each file segment and based on an “index map” that governs how each file segment is sequenced.

Pursuant to providing the complete file to the consumer or user, the IPCC 110 verifies the presence of an appropriate DVD disk and computer drive, and transfers the file in a standard DVD format to that disk, i.e. a disk is burned at the computer 125 of the user. In the preferred embodiment, these steps are controlled and managed by the IPCC 110 via a variety of known software libraries that provide the control and management functionality.

In addition, the IPCC 110, at the consumer's request, forwards data that is used by the consumer or user to print liner notes and cover art at the consumer's computer 125 in a format such that the notes and cover art can be included in a standard plastic case, e.g., a jewel case provided by the consumer.

In an embodiment of the present invention, independent films made by filmmakers 140 are digitally encoded for distribution over the system 100 to consumers or users. In the preferred embodiment, the filmmakers are independent filmmakers and the consumers or users are independent film viewers. Pursuant to implementation of the present embodiment, independent filmmakers are encouraged to distribute their films via the IPCC 110 based on contractual agreements that are executed in advance, such as a non-exclusive license. Examples of independent film collections are the 2005 Student Film Collection and the International Documentary Association collection. It is contemplated that other collections are under development for subsequent distribution via the IPCC to consumers or users. Uploading of films to the database at the IndiePix provider 105 in this manner creates a sizable collection of films that can be searched by consumers or users.

In accordance with the commercial aspects of the contemplated embodiments, filmmakers that distribute their titles via the Indie Pix Control Center (IPCC) 110 will also receive the proprietary software of the IPPC 110 and will be registered with the IndiePix web site 117b. For a fee, the independent filmmakers upload their digitally encoded films to the IndiePix web site 117b, where the digitally encoded films are then associated with a title to permit searching of the database using known search tools and methods.

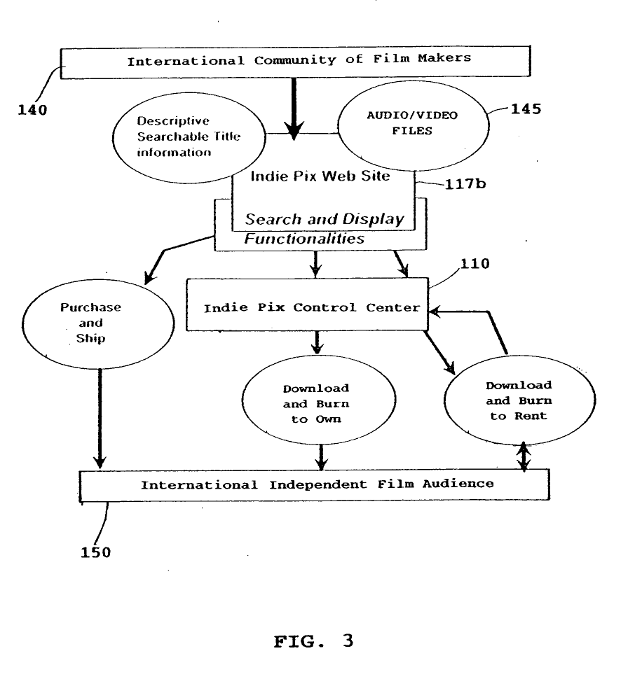

FIG. 3 is a schematic block diagram of an exemplary business model associated with distributing audio, video or audio/video content in accordance with the disclosed embodiments of the invention. The international community of independent filmmakers 140 are encouraged to distribute their titles via the IPCC 110 based on contractual agreements that are executed in advance, such as a non-exclusive license. Here, each independent filmmaker can access the IndiePix website 117b to upload digitally encoded audio, video or audio/video data files 145 for distribution to the international independent file audience 150, i.e., the consumer or user. The international independent film audience 150 is provided with the proprietary software of the IPPC 110 which can be obtained, for example, by attending film festivals in the United States or throughout the world.

In accordance with the business model illustrated in FIG. 2, the independent filmmakers are also provided with the proprietary software of the IPCC 110 to permit them to pay a fee, register with the IndiePix website 117b and distribute their titles via the IPPC. In this manner, a nexus is created between the independent filmmakers 140 and the independent film audience 150. By participating in film festivals and through the use of promotional offers to attendees of these festivals, the distribution of independent films to the audience of independent film viewers 150 can occur, and the creation of a revenue stream can be achieved.

The international filmmakers 140 access the IndiePix website 117b and upload their digitally encoded films to the website 117b, where they become associated with specific titles to permit keyword searching of the database using known search tools and methods. As a result, it becomes possible for the international independent film audience 150 (i.e., consumers and users) to search and locate titles of interest located in the database of the IndiePix website 117b. Once a title of interest has been identified on the IndiePix web site 117b, the video or audio/video title may be selected from links presented on the home page of the IndiePix web site 117b, from a search for a title, or from the result of browsing the IndiePix web site 117b.

Having retrieved a particular title of interest, i.e., the digitally encoded file associated with a particular independent film, the independent film viewer (i.e., a consumer or user) has several options with respect to the retrieved title. The viewer 150 may pay a fee to purchase a DVD that may be manufactured to order, depending on availability, or shipped from one of several wholesalers or third party suppliers that may stock the specific title. The viewer may pay to purchase a data file incorporating the video or audio/video information associated with the particular title of interest that is downloaded from the IndiePix website 117b via the IPCC 110 and distribution server 135, and to the consumer's computer 125 via the Internet X10 for subsequent transfer to a blank DVD disk provided by the consumer for permanent ownership, i.e., download and burn-to-own. Finally, the viewer may pay to purchase a data file incorporating the video or audio/video information of the title for viewing for a temporary period of time, i.e., download-to-rent.

A credit card provided by viewer 150 that can be maintained on file can be used for payment. Other traditional forms of payment may also be used, where the viewer 150 would mail traditional forms of payment, such as cash, money orders or checks, which would be applied to an account of the consumer or user that is maintained at the IndiePix website 117b. Alternatively, payment for download of the audio, video or audio/video information may be achieved by way of known Internet payment methods, such as PayPal® or CyberCash®.

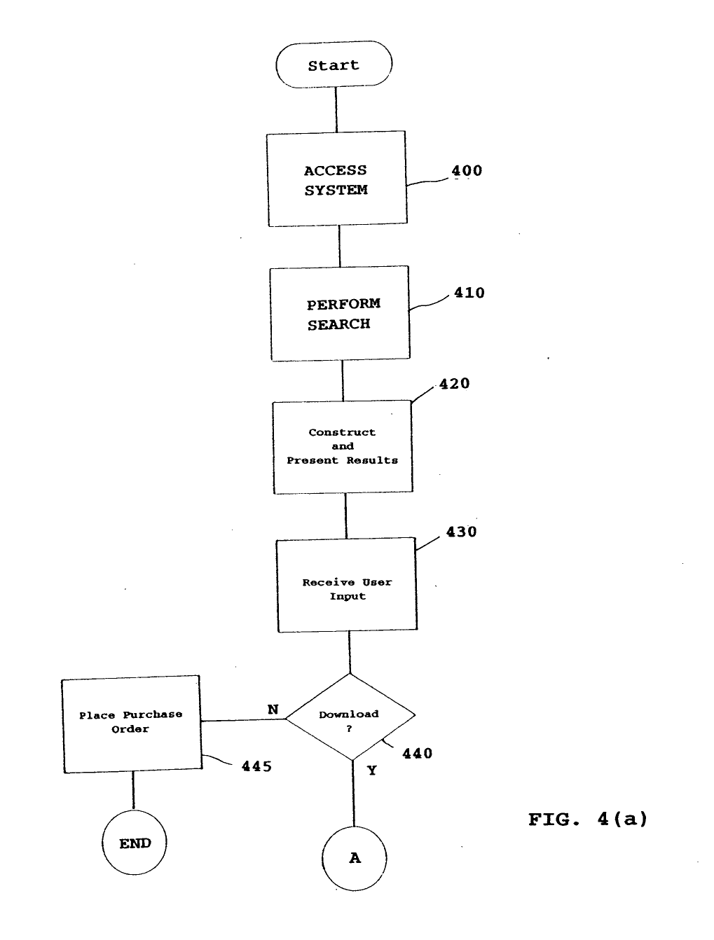

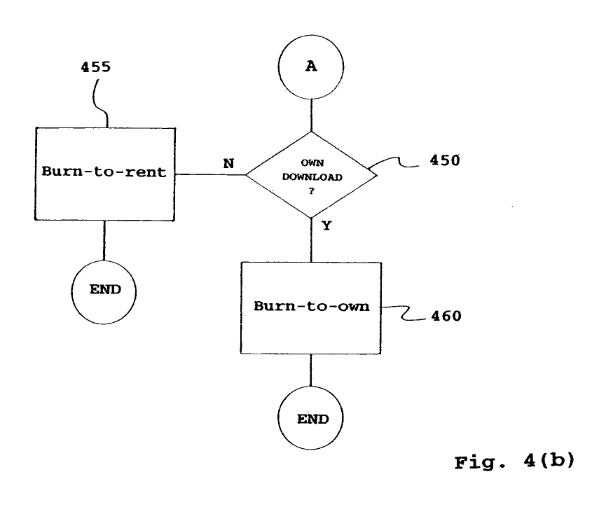

FIG. 4 illustrates the steps of the method of the invention. A consumer or user accesses the system 100 via the Internet 120 and their computer 125, as indicated in step 400. Here, the consumer may use his computer 125 to access the distribution control center server 110 over the Internet 120 via a conventional URL, such as IndiePix.net.

Next, the consumer or user performs a search of the IndiePix database (not shown) located at the IndiePix provider 105 to locate a title of a specific audio, video or audio/video file associated with the title, as indicated in step 410.

Upon identification of a title of interest on the IndiePix website 117b by the consumer or user, at least one link indexed to the title is presented on the home page of the IndiePix web site 117b for selection by the consumer or user, as indicated in step 420. In alternative embodiments, the at least one link is generated based on a user search for a title or from the result of browsing the IndiePix web site. In accordance with the disclosed embodiments, when a consumer or user selects a title, a home page with complete information about the audio, video or audio/video file is constructed and presented to the consumer using known dynamic programming techniques.

Moreover, the search presented to the consumer or user is arranged in a manner such that the searches “radiate” out from the target (i.e., a “hit”) in much the manner as the spokes on a wheel. Here, the dimension of the search is defined by the “keywords” used to perform the search. Examples of dimensions of the search include: geographical location of the title, filmmaker or keywords representing the theme of the title. In one embodiment, near matches are arranged along these spokes so as to suggest the range of titles that approximate the consumer's keyword search. Such a search capability is uniquely programmed for the present invention and includes specific ways in which the dimensions represented by the spokes are dynamically defined, selected titles are positioned along the spokes in the slots, and in which “near match” titles are positioned along the dimensions in proximity to the center of the wheel/spoke arrangement. In accordance with disclosed embodiments, each title is indexed to multiple “tags”, where the tags are analyzed during a search to locate other titles indexed to each tag so as to determine whether there is a correspondence between the titles or tags. If a correlation is found, then the link is placed in a slot of the wheel/spoke arrangement based on the relevance to the core title.

The consumer or user may click on each title or slot and obtain details associated with the title, such as year of creation, director, actors, duration, etc.

Upon selection of a particular title, the wheel/spoke arrangement would be redrawn, where the newly selected title would then appear at the center of a new wheel/spoke arrangement. In this manner, the consumer or user may perform knowledge based browsing or searching to locate specific titles of interest. The present invention is not limited to searching on specific titles. In contemplated embodiments, it is possible to perform a search on a specific theme.

Having retrieved a particular title of interest, e.g. an audio, video or audio/video file associated with a particular film, the consumer or user may select one of several options with respect to the retrieved title. The selected input of the consumer or user with respect to the retrieved title is then received at the IPPC 110 via the Internet 120, as indicated in step 430. Here, the consumer or user may chose to purchase a DVD that may be manufactured to order, depending on availability, or shipped from one of several wholesalers or third party suppliers 130 that may stock the specific title. The consumer or user may choose to purchase a data file incorporating the audio, video or audio/video information for the particular title of interest that is downloaded from the IndiePix website 117b via the IPCC 110 and distribution servers 135, and to the consumer's computer 125 via the Internet 120 for subsequent transfer to a blank DVD disk provided by the consumer for permanent ownership, i.e., download and burn-to-own. Finally, the consumer or user may purchase a data file incorporating the audio, video or audio/video information of the title for viewing for a temporary period of time, i.e., download-to-rent.

Next, a check is performed to determine whether the user has chosen to download the data file incorporating the audio, video or audio/video information for the particular title of interest, as indicted in step 440. If the consumer or user has not chosen the download option, then the consumer or user places an order for a DVD that may be manufactured or shipped from one of several wholesalers or the third party suppliers 130 that may stock the specific title, as indicated in step 445. A credit card provided by the consumer or user that can be maintained on file can be used for payment. Other traditional forms of payment may also be used to effect payment, where the consumer or user would mail traditional forms of payment, such as cash, money orders or checks, which would be applied to an account of the consumer or user that is maintained at the IndiePix website 117b. Alternatively, payment may be achieved by way of known Internet payment methods, such as PayPal® or CyberCash®.

If the input received from the consumer or user at the IPPC 117b indicates that the consumer or user has chosen the download option, then a check is performed to determine whether the consumer or user wants to download the audio, video or audio/video information associated with the particular title of interest for permanent ownership, as indicated in step 450. If the consumer or user wants to download this particular audio, video or audio/video information, then the data file comprising the audio, video or audio/video information is downloaded to the consumer or user, as indicated in step 455.

Prior to download of the audio, video or audio/video information digital file, it is encoded with an identifiable digital “watermark”—encoded randomly throughout the digital file—that specifies the identify of the consumer or user that initiated the download of the digital file. This watermark remains with the digital file in any subsequent copies, and provides deterrence against illegal copying for commercial gain. Such watermarking may be accomplished using known watermarking methods, such as via the software package MPEGEscort™ manufactured by PixelTools. In accordance with the contemplated embodiments of the invention, the watermark can be downloaded with or without the data file. In embodiments where the data file is downloaded without the watermark, it is downloaded and inserted into the downloaded file at the consumer's computer 125.

In addition, the file to be downloaded is segmented into a predetermined number of elements to reduce server loads, as well as increase processing speed by reducing the processing bandwidth, i.e., the amount of information downloadable from a webserver over a prescribed period of time. The segmentation of the file to be downloaded occurs at the IPCC server 117b. As a result, server loading is minimized because the load is distributed among multiple remote servers 135′. Each element of the sectioned file is provided with a predetermined encoded sequence number. In addition, each element of the sectioned file that is delivered to the consumer is allocated randomly to each of the distribution servers 135′, each of which separately delivers its portion of the file to the consumer or user via the Internet 120. In this manner, a high level of security is provided, because the data file is segmented and distributed among the servers 135′ such that unauthorized users cannot access the entire data file from a single point of access.

After all the elements are received by the consumer or user at their computer, the IPCC 110 organizes the file elements in an appropriate order based on the sequence codes in each file segment and based on a “index map” that governs how each file segment is sequenced.

The IPCC 110 then verifies the presence of an appropriate DVD disk and computer drive, and transfers the file in a standard DVD format to that disk, i.e. a disk is burned at the consumer's computer. In the preferred embodiment, these steps are controlled and managed by the IPCC 110 via a variety of known software libraries that provide the control and management functionality.

In addition, the IPCC 110, at the consumer's request, forwards data that is used by the consumer or user to print liner notes and cover art at the consumer's computer 125 in a format such that the notes and cover art can be included in a standard plastic case, e.g., a jewel case provided by the consumer.

If the input received from the consumer or user at the IPPC 110 indicates that the consumer or user wishes to download the audio, video or audio/video information associated with the particular title of interest for temporary rental, then a data file incorporating the audio, video or audio/video information of the title is downloaded to the consumer or user for subsequent viewing for a temporary period of time, as indicated in step 460. This downloaded file is only transferable to a specific disk that is provided by the IndiePix provider 105 or encoded via the IPCC 110. The audio, video or audio/video information of the data file is transferred to this specific disk. However, subsequent titles are transferred to that same disk, after erasure of the prior contents of the disk. Typically, consumers or users will be required to possess a DVD drive that is configured to read such re-writable disks. Irrespective of such a requirement, the proprietary software of the IPCC 110 verifies that a properly coded disk is in the disk drive of the consumer's computer 125, and that the prior contents have been erased before transferring the new file to that disk.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for distributing audio, video or audio/video content, comprising:
accessing a database at a service provider to perform a search of the database via the Internet;
searching the database at the service provider to locate a title of the audio, video or audio/video content associated with the title;
presenting at least one link indexed to the title for selection of the title in the database;
receiving the selection of the at least one link at the service provider via the Internet;
determining whether a download of a data file incorporating the audio, video or audio/video content associated with the at least one link indexed to the title has been requested;
determining whether permanent ownership of the requested audio, video or audio/video content associated with the title is desired in the event the at least one link indexed to the title has been requested;
if permanent ownership of the requested audio, video or audio/video content associated with the title is desired, segmenting the data file into a number of elements at a first server and distributing each of the segmented elements among at least one second server; and
downloading each segmented element from the at least one second server to a computer via the Internet for playback based on sequence codes in each segmented element.

2. A method for distributing audio, video or audio/video content, comprising:
receiving payment to permit access to a website to upload digitally encoded audio, video or audio/video data files to a database for distribution to a consumer or user;
accessing the website and uploading the digitally encoded data files to the website subsequent to payment of the fee;
associating the uploaded data files with specific titles to permit keyword searching of the database;
searching the database at a service provider to locate a title of the audio, video or audio/video content associated with the title upon payment of the fee;
presenting at least one link indexed to the title for selection at a home page of the service provider upon identification of the title in the database;
receiving the selection of the at least one link at the service provider via the Internet;
determining whether a download of a data file incorporating the audio, video or audio/video content associated with the at least one link indexed to the title has been requested;
determining whether permanent ownership of the requested audio, video or audio/video content associated with the title is desired in the event the at least one link indexed to the title has been requested;
receiving payment for permanent ownership of the requested audio, video or audio/video content associated with the title;
if permanent ownership of the requested audio, video or audio/video content associated with the title is desired, segmenting the data file into a number of elements at a first server and distributing each of the segmented elements among at least one second server upon receipt of payment; and
downloading each segmented element from the at least one second server to a computer via the Internet for playback based on sequence codes in each segmented element.

3. The method of claim 1, further comprising:
placing a purchase order for the data file incorporating the audio, video or audio/video content associated with the at least one link indexed to the title if a download is not requested.

4. The method of claim 3, wherein the data file incorporating the audio, video or audio/video content comprises a DVD that is manufactured or shipped from at least one of an wholesaler and third party suppliers that stock the title.

5. The method of claim 3, wherein a credit card that is maintained on file is used to pay for the DVD.

6. The method of claim 3, wherein payment is achieved by way of the Internet.

7. The method of claim 6, wherein Internet payment comprises use of at least one of PayPal® and CyberCash®.

8. The method of claim 1, wherein the audio, video or audio/video content is encoded with a digital watermark prior to being downloaded.

9. The method of claim 8, wherein the digital watermark is encoded randomly throughout the content.

10. The method of claim 8, wherein the digital watermark specifies an identify of an initiator of the download of the content.

11. The method of claim 10, wherein the digital watermark remains with the downloaded content in subsequent copies of the content.

12. The method of claim 8, wherein the digital watermark is one of downloadable with and downloadable without the content file.

13. The method of claim 12, wherein the watermark is downloaded and inserted into the downloaded content at the computer if the content is downloaded without the digital watermark.

14. The method of claim 1, wherein each predetermined element of the segmented data file is provide with a predetermined encoded sequence number.

15. The method of claim 1, wherein each segmented element downloaded to the computer is allocated randomly to a respective distribution server.

16. The method of claim 15, wherein each respective distribution server delivers a portion of the content to the computer via the Internet.

17. The method of claim 1, further comprising:
organizing each segmented element based on the sequence codes in each segmented element and based on an index map that determines how each file segment is sequenced after all segmented elements are received at the computer.

18. The method of claim 17, wherein the control center server organizes the segmented elements at the computer over the Internet.

19. The method of claim 17, further comprising:
verifying, at the control center server via the Internet, a presence of a DVD and computer drive in the computer; and
transferring the content if a DVD and computer drive are in the computer.

20. The method of claim 19, wherein said transferring comprises creating a viewable DVD at the computer.

21. The method of claim 19, wherein said verifying and transferring steps are performed under control and management of the control center server.

22. The method of claim 1, further comprising:
downloading to the computer a data file incorporating information of the title associated with the audio, video or audio/video content for temporary viewing if ownership of the requested audio, video or audio/video content is not desired.

23. The method of claim 1, wherein the downloaded data file is only transferable to a specific disk that is encoded via the central control server.

24. A system for distributing audio, video or audio/video content, comprising:
a service provider center comprising a control center server and a remote computer, said control center server segmenting a downloaded data file incorporating the audio, video or audio/video content associated with at least one link indexed to the title;
a distribution center server configured to receive the segmented data file for distribution via the Internet to at least one remotely located computer; and
a module located in the at least one remotely located computer for initiating downloads of the segmented data file to the at least one remotely located computer.

25. A method for distributing audio, video or audio/video content, comprising:
accessing a website and uploading digitally encoded audio, video or audio/video data files to a database for distribution to a consumer or user;
associating the uploaded data files with specific titles to permit keyword searching of the database;
searching the database at a service provider to locate a title of the audio, video or audio/video content associated with the title upon payment of the fee;
presenting at least one link indexed to the title for selection at a home page of the service provider upon identification of the title in the database;
receiving the selection of the at least one link at the service provider via the Internet;
determining whether a download of a data file incorporating the audio, video or audio/video content associated with the at least one link indexed to the title has been requested;
determining whether permanent ownership of the requested audio, video or audio/video content associated with the title is desired in the event the at least one link indexed to the title has been requested;
receiving payment for permanent ownership of the requested audio, video or audio/video content associated with the title;
if permanent ownership of the requested audio, video or audio/video content associated with the title is desired, segmenting the data file into a number of elements at a first server and distributing each of the segmented elements among at least one second server upon receipt of payment; and
downloading each segmented element from the at least one second server to a computer via the Internet for playback based on sequence codes in each segmented element.

26. The method of claim 25, further comprising:
receiving payment to permit access to the website such that upload of the digitally encoded audio, video or audio/video data files to a database for distribution to a consumer or user becomes enabled.

27. The method of claim 25, wherein payment is received contemporaneously with upload of the digitally encoded audio, video or audio/video data files.

28. The method of claim 25, further comprising:
creating upload records to perform subsequent billing for upload of the digitally encoded audio, video or audio/video data files to the database.

29. The method of claim 28, wherein the subsequent billing is performed based on at least one of length of time of the audio, video or audio/video data files and total size of the audio, video or audio/video data files.
